(19) United States
(12) Patent Application Publication
(10) Pub. No.: US 2015/0104969 A1
(43) Pub. Date: Apr. 16, 2015

(54) FASTENER

(71) Applicant: KEMAX SHING CO., LTD., NEW TAIPEI CITY (TW)

(72) Inventors: SHIH-CHUN TENG, NEW TAIPEI CITY (TW); YA-HUI HSU, NEW TAIPEI CITY (TW)

(73) Assignee: KEMAX SHING CO., LTD., NEW TAIPEI CITY (TW)

(21) Appl. No.: 14/053,652

(22) Filed: Oct. 15, 2013

(51) Int. Cl. H01R 13/627

(52) U.S. Cl. CPC H01R 13/6275
USPC 439/358

(57) ABSTRACT

A fastener is made of a plastic material by integrated injection molding and has a locking portion and an installation portion, wherein the locking portion has two arm levers extended and arranged at a predetermined interval, and at least a concave buckle corresponding to another is respectively protruded from inner sides of the two arm levers. The installation portion has a cap connected to the two arm levers. A channel passing between the two arm levers is disposed to the cap, and at least an elastic hook plate is disposed at a bottom of the cap. While in use, the locking portion is stretched into the fastener insertion hole preset at the side of the notch of the board insertion slot. The elastic hook plate at the bottom of the cap is mutually buckled with the buckle hole of an inner wall of the fastener insertion hole.

### BACKGROUND OF THE INVENTION

1. Field of the Invention

The invention relates to a fastener, and more particularly to a fastener installed in a correspondingly board insertion slot and generating a locking effect for a board inserted into the board insertion slot.

2. Description of the Related Art

As everyone knows, “computer” is a kind of generic term for different types of logic operation host and can be divided according to purposes and forms. A computer can be generally divided into a server and a personal computer (PC). In addition, the type and form of PC are also evolved continuously, including desktop PCs, laptop PCs, notebook PCs, personal digital assistants (PDA), and tablet PCs.

Since the functionality and stability of a desktop PC are continuously improved, it replaces a mainframe computer in the past as a server. Further, the host of the desktop PC can be assembled or expanded to have more functions and operational efficiency according to demands of the user. Thus, it widely goes deep into normal companies and families to take the highest market share in all computer types. Generally, the host of the desktop PC mainly includes a case, a motherboard, a central processing unit (CPU), a memory module, a sound card, a display card, a power supplier and data storage equipment such as hard disk drive, optical disk drive, CD burner, etc.

While assembling computer hosts, the CPU, the memory, the sound card and the display card are directly embedded into different types of insertion slots. Moreover, to match the self-expanding function configured by the user, a modularized board design is further developed, and a buckle bolt capable of being twisted is disposed at two ends of the insertion slot corresponding to the board. The effect of fixing the board can be enhanced by the buckle bolt.

Since the space arrangement problem occurs inside the computer host, many users are interfered with components of the optical disk drive, the hard drive, buses or other boards. Consequently, the buckle bolts at the two sides of the insertion slot are unable to be twisted to affect normal motion of plugging the board. To face the foregoing situation, the buckle bolt at one side of the insertion slot on the motherboard of the host is replaced with the fastener that is no need to be rotated.

Similar conventional fasteners are mainly composed of a metal component buried in the insertion slot and a plastic component relatively protruded the insertion slot. The board inserted at proper position can be locked by mainly utilizing the metal component. When necessary, the metal component can be pushed by utilizing the plastic component so that the board locked by the metal component can be released to smoothly withdraw the board. However, the structural design increases mold and material costs, and assembling process is also complicated. Moreover, the plastic component will be rubbed after pushing the metal component many times. Consequently, two different components are unable to be actuated actually.

Related prior arts can be referred to Taiwan Patent No. M411711 published on Sep. 11 2011. The patent disclosed a card edge connector for plug the electric card and that includes a longitudinal insulation main body, a plurality of conductive terminals contained inside the insulation main body and a locking structure for locking the electric card installed at a side of the insulation main body. The insulation main body is disposed with a central insertion slot inserted by the electric card and expanded along a longitudinal direction, and a plurality of terminal receiving slots for receiving the conductive terminals and located at two sides of the central insertion slot. The locking structure includes a retention portion engaged with the insulation main body and an elastic arm upwardly extended from the retention portion. The elastic arm includes a card locking portion for locking the electric card and a support surface located below the card locking portion and capable of preventing the electric card from being shaken along the direction of vertically inserting the electric card after inserting the electric card.

In the foregoing prior art, although the support surface is provided to prevent the electric card from being upwardly shaken in the direction of vertically inserting the electric card to further ensure the stability of locking the card, the conventional technique still has the following shortcomings:

1. The locking structure is assembled toward the insulation main body from the bottom to the top. The retention portion can be engaged with the insulation main body. However, while downwardly imposing force to insert the electric card, the locking structure is also pushed downwardly to disengage the locking structure from the insulation main body to cause worse assembling strength.

2. Only the retention portion at the bottom of the locking structure is engaged with the insulation main body. Other tools are still required while in assembly. Consequently, assembling convenience is reduced as well.

### SUMMARY OF THE INVENTION

Therefore, upon the foregoing problems of prior art, it is an objective of the present invention to provide a fastener installed in a correspondingly board insertion slot and capable of being easily assembled, relatively having stable and reliable structure, and greatly reducing manufacture costs

To achieve the foregoing objective, the fastener according to the invention is made of a plastic material through integrated injection molding. The fastener includes the following structure: a locking portion relatively located below the fastener and having two arm levers extended and arranged at a predetermined interval, at least a concave buckle, which corresponds to another, respectively protruded from inner surfaces of the two arm levers; and an installation portion relatively located on the fastener and having a cap connected to the two arm levers, a channel, which passes between the two arm levers, disposed to the cap, at least an elastic hook plate disposed to a bottom of the cap.

By utilizing the foregoing structure, the fastener according to the invention can be installed to the correspondingly board insertion slot. By principally using the manner of mutually aligning the interval of the two arm levers and the notch of the board insertion slot, the locking portion of the fastener is stretched into the fastener insertion hole preset at the side of the notch of the board insertion slot. The elastic hook plate at the bottom of the cap is mutually buckled with the buckle hole of an inner wall of the fastener insertion hole to quickly install the whole fastener to the proper position. While inserting the applied board, the board edge of the board can be stretched into the interval of the two arm levers along the channel of the cap. After the board is inserted into the proper position, the convex buckles at inner sides of the two arm levers are correspondingly buckled in the gap preset along a board edge of the board so that the board can be prevented from being withdrawn in order to generate locking effect. When necessary, only the cap of the fastener is pressed toward the direction of the bottom of the board insertion slot to outwardly bend the two arm levers so that the concave buckles at inner sides of the two arm levers are ejected from the gap of the board to smoothly withdraw the board, thereby achieving purposes of easy assembling, stable and reliable structure, and greatly reducing manufacture costs.

Specifically, the fastener according to the invention has the following effects:

1. The whole fastener is made of the plastic material by integrated injection molding to relatively reduce mold and material costs.

2. The whole fastener can be quickly installed to proper position through one-time insertion motion so as to relatively have assembling convenience.

3. While using the whole fastener, the problem of mutually rubbing against different components may not occur so that the whole structure can relatively have stability and reliability.

4. The height drops possibly existing among the gaps of the different boards can be further compensated through the design of the pressing inclined surface having the slope so that the applied board can be stably locked.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic diagram of usage configuration of a fastener according to the invention;

FIG. 2 is a three-dimensional diagram of appearance of a fastener according to the invention;

FIG. 3 is a schematic diagram of assembling a fastener according to the invention;

FIG. 4 is a cross-sectional drawing of usage configuration of a fastener according to a first embodiment of the invention;

FIG. 5 is a cross-sectional drawing of usage configuration of a fastener according to a first embodiment of the invention;

### DETAILED DESCRIPTION OF THE PREFERRED EMBODIMENTS

The technical content of the present invention will become apparent by the detailed description of the following embodiments and the illustration of related drawings as follows.

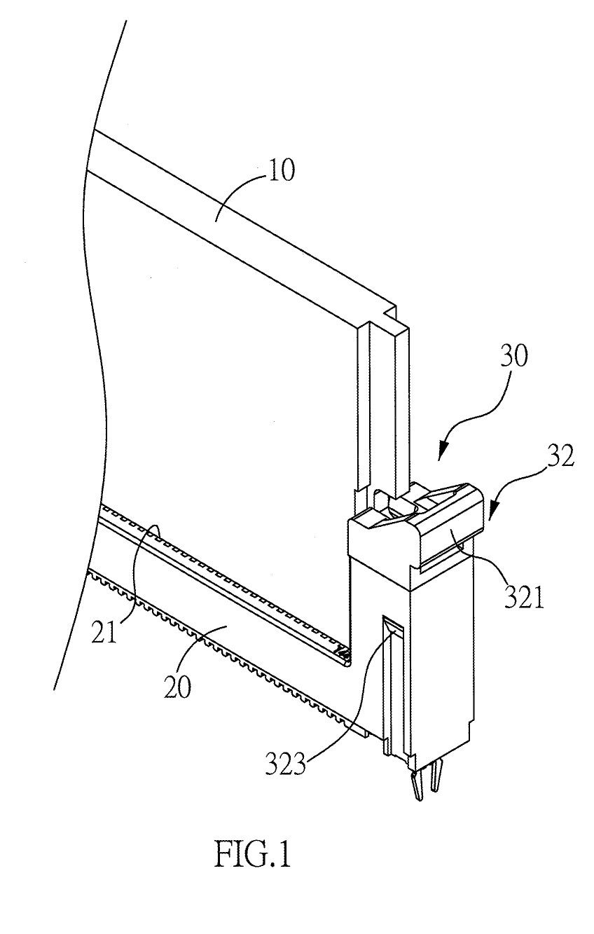

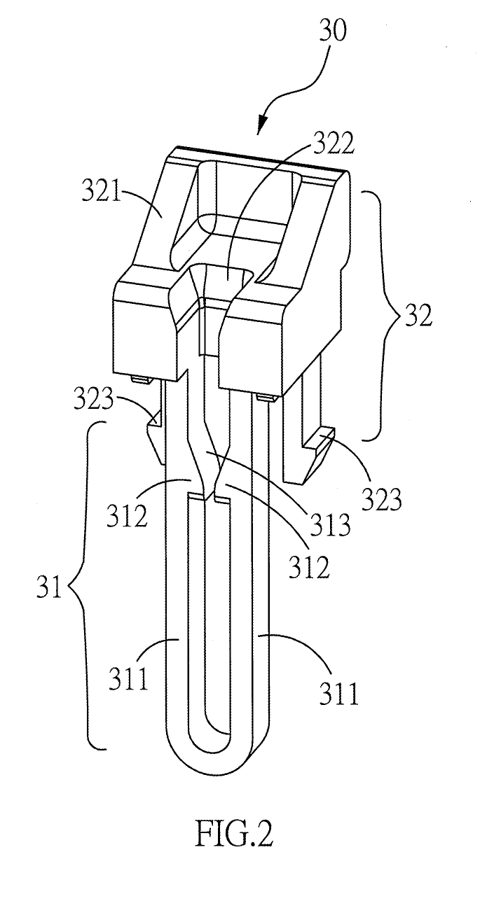

With reference to FIG. 1 for a schematic diagram of usage configuration of a fastener according to the invention is depicted. The invention discloses a fastener 30 installed to a correspondingly board insertion slot 20 and that principally generates locking effect for a board 10 inserted into the board insertion slot 20. With reference to FIG. 2 for a three-dimensional diagram of appearance of the fastener according to the invention is depicted. The fastener 30 according to the invention is basically made of a plastic material through integrated injection molding. The whole fastener 30 further comprises the following structures:

a locking portion 31 relatively located below the fastener 30 and having two arm levers 311 extended and arranged at a predetermined interval, and at least a convex buckle 312, which corresponds to another, respectively protruded from the inner sides of the two arm levers 311, wherein the board 10 stretched thereto can be pressed by utilizing the convex buckles 312 so as to lock the board 10, and tails of the two arm levers 311 of the locking portion 31 are connected to form a bent arc shape in the embodiment so that not only the structural strength of the fastener 30 can be increased, but also the bent arc shape connected by the tails of the two arm levers 311 leans against the structure below thereto when the locking portion 31 is downwardly displaced, and accordingly, the two arm levers 311 can be further guided and outwardly bent;

an installation portion 32 having a cap 321 connected to the two arm levers 311 and relatively located on the whole fastener 30, a channel 322 passing between the two arm levers 311 disposed to the cap 321, at least an elastic hook plate 323 disposed to the bottom of the cap 321, wherein the installation portion 32 is disposed with a pair of elastic hook plates 323 respectively arranged to exterior sides of the two arm levers 311 at the bottom, and the correspondingly board insertion slot 20 is mutually combined with the flexible hook plate 323, and the whole fastener 30 is restricted to upwardly and downwardly displace relative to the board insertion slot 20 in a predetermined stroke.

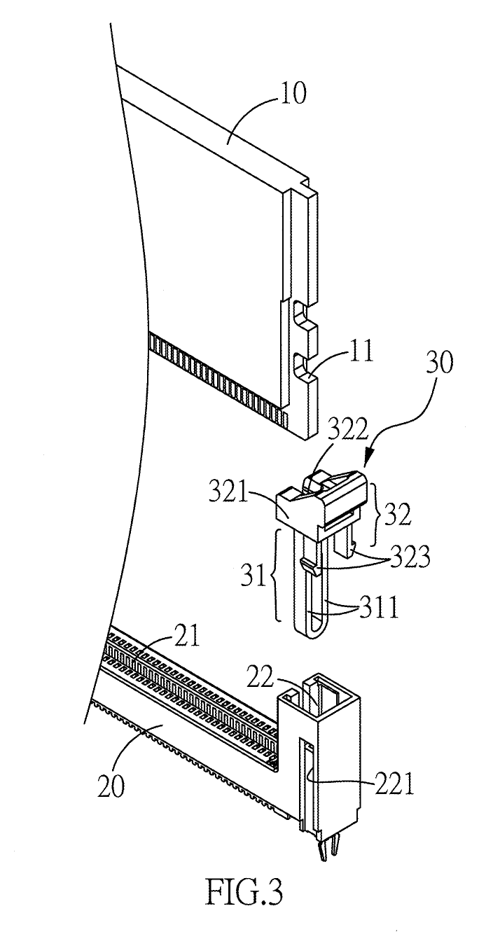

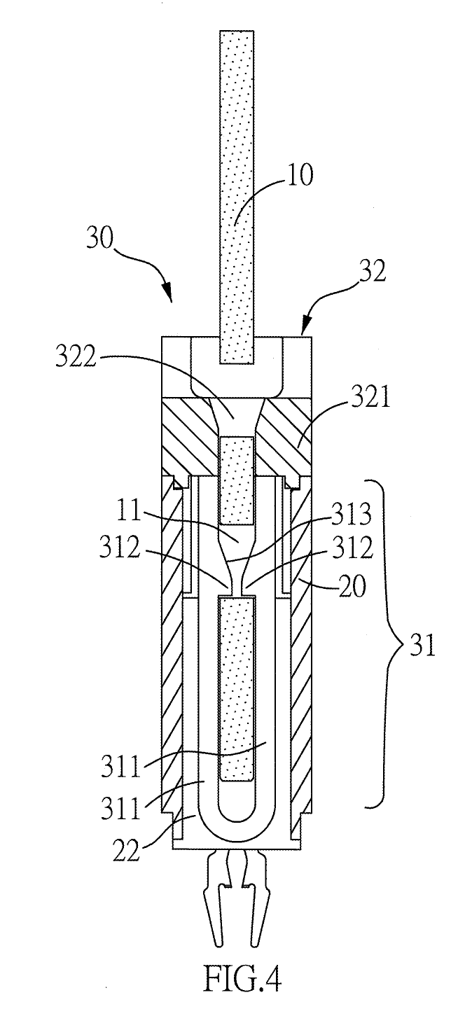

With reference to FIG. 3 and FIG. 4, the fastener 30 according to the invention can be installed in the correspondingly board insertion slot 20 through a simple insertion motion. The locking portion 31 of the fastener 30 can be stretched into the fastener insertion hole 22 preset at the side of the notch 21 of the board insertion slot 20 through a manner of mutually aligning the interval of the two arm levers 311 and the notch 21 of the board insertion slot 20.

Since the elastic hook plate 323 at the bottom of the cap 321 is mutually buckled with the buckle hole 221 of an inner wall of the fastener insertion hole 22, the whole fastener can be quickly installed at proper position.

When the board 10 is inserted, the board edge of the board 10 can be stretched into the interval of the two arm levers 311 along the channel 322 of the cap 321, and after the board 10 is inserted into the proper position, the convex buckles 312 at inner sides of the two arm levers 311 is correspondingly buckled in the gap 11 preset along a board edge of the board 10 so that the board 10 can be prevented from being withdrawn in order to generate locking effect. Further, the fastener 30 is a plastic material and has an elastic body characteristic. When the thickness of the board 10 is greater than the interval of the two correspondingly concave buckles 312, the board 10 goes deep into the convex buckles 312 by passing through the channel 322 of the cap 321 such that the two arm levers 311 are elastically and outwardly expanded until the concave buckles 312 is correspondingly in touch with and buckled into the gap 11 of the board 10. Therefore, the bent arc shape of the tails of the two arm levers 311 can be sprung back and restored to allow the concave buckles 312 to buckle the gap 11 of the board 10 to achieve the positioning, and the board 10 can be restricted and prevented from being withdrawn in order to generate a locking effect.

When necessary, only the cap 321 of the fastener 30 is pressed toward the direction of the bottom of the board insertion slot 20 to outwardly bend the two arm levers 311 of the locking portion 31 so that the concave buckles 312 at inner sides of the two arm levers 311 are ejected from the gap 11 of the board 10 to smoothly withdraw the board 10, thereby achieving purposes of easy assembling, stable and reliable structure, and greatly reducing manufacture costs. Alternatively, while withdrawing the board 10, the cap 321 of the fastener 30 is outwardly pushed toward a direction that is opposite to the board 10 to allow the fastener 30 and the board to present a slope so that the concave buckles 312 at inner sides of the two arm levers 311 are ejected from the gap 11 of the board 10, and another of the board 10 that is distant from the cap 321 is taken as an axis, the board 10 is rotated and upwardly pulled to complete ejection.

Moreover, while implementing the fastener 30 according to the invention, tops of the concave buckles 312 of the fastener 30 can be respectively formed with a guide inclined surface 313 having a predetermined slope so that the board 10 can be smoothly inserted to proper position under the slope effect of the guide inclined surface 313, thereby increase the usage convenience of the whole fastener 30.

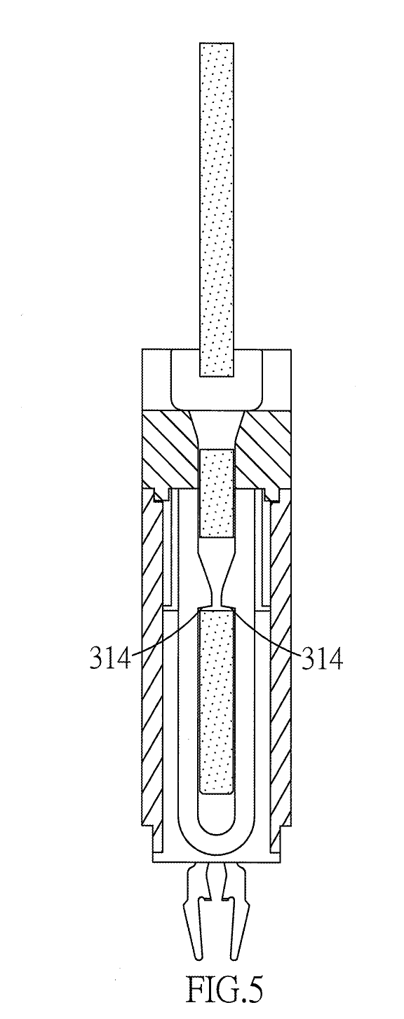

It should be noted that regardless of the top of each concave buckle 312 of the fastener 30 formed with a guide inclined surface 313 having the predetermined slope, a bottom of the each concave buckle 312 of the whole fastener 30, as shown in FIG. 5, is formed with a pressing inclined surface 314 having the predetermined slope while in implementation, and the slope of the pressing inclined surface 314 that is smaller than the slope of the guide inclined surface 313 is preferable. Therefore, the height drops possibly existing among the gaps 11 of different boards 10 can be compensated through the design of the pressing inclined surface 314 having the slope so that the applied board 10 can be stably locked, and the applicability and practicality of the whole fastener 30 can be increased at the same time.

By comparing with the conventional structure, the fastener according to the invention can have the following effects.

1. The whole fastener is made of the plastic material by integrated injection molding to relatively reduce mold and material costs.

2. The whole fastener can be quickly installed to proper position through one-time insertion motion so as to relatively have assembling convenience.

3. While using the whole fastener, the problem of mutually rubbing against different components may not occur so that the whole structure can relatively have stability and reliability.

4. The height drops possibly existing among the gaps of the different board can be further compensated through the design of the pressing inclined surface having the slope so that the applied board can be stably locked.

While the means of specific embodiments showing a preferable fastener according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A fastener made of a plastic material by integrated injection molding, the fastener comprising:
a locking portion relatively located below the fastener and having two arm levers extended and arranged at a predetermined interval, at least a concave buckle, which corresponds to another, respectively protruded from inner surfaces of the two arm levers; and
an installation portion relatively located on the fastener and having a cap connected to the two arm levers, a channel, which passes between the two arm levers, disposed to the cap, at least an elastic hook plate disposed to a bottom of the cap.

2. The fastener of claim 1, wherein a guide inclined surface having a predetermined slope is formed at a top of each concave buckle of the fastener.

3. The fastener of claim 1, wherein a pressing inclined surface having a predetermined slope is formed at a bottom of each concave buckle of the fastener, and the predetermined slope of the pressing inclined surface is smaller than the predetermined slope of the guide inclined surface.

4. The fastener of claim 1, wherein a guide inclined surface having a predetermined slope is formed at a top of each concave buckle of the fastener, and a pressing inclined surface having a predetermined slope is formed at a bottom of each concave buckle, and the predetermined slope of the pressing inclined surface is smaller than the predetermined slope of the guide inclined surface.

5. The fastener of claim 1, wherein tails of the two arm levers of the locking portion are connected together to form a bent arc shape.

6. The fastener of claim 1, wherein a pair of elastic hook plates respectively arranged to exterior sides of the two arm levers is disposed at a bottom of the cap of the installation portion.
